(19) United States
(12) Patent Application Publication
(10) Pub. No.: US 2016/0349433 A1
(43) Pub. Date: Dec. 1, 2016

(54) ILLUMINATED WINDOW DISPLAY

(71) Applicant: OptoGlo Inc., Leominster, MA (US)

(72) Inventor: Kevin G. Donahue, Harvard, MA (US)

(21) Appl. No.: 15/164,562

(22) Filed: May 25, 2016

Related U.S. Application Data
(60) Provisional application No. 62/166,315, filed on May 26, 2015.

(51) Int. Cl. F21V 8/00

(52) U.S. Cl. CPC G02B 6/006; G02B 6/0081; G02B 6/0068; G02B 6/0065

(57) ABSTRACT

Systems and methods of the disclosure can provide an illuminated window display. In one aspect, a device having a light source, a light guide, and a layer of optical adhesive can be adhered to a window pane such that the device passes light into the window pane at an angle greater than a critical angle for total internal reflection of the window pane immersed in air. The light can be reflected back into the window pane from a portion of a surface of the window pane interfacing with air. The light can be emitted from the window pane from a second portion of the surface of the window pane interfacing with a graphical element. The graphical element can include a marking or decal on the surface of the window pane. The effect of the device is to illuminate the graphical element.

### RELATED APPLICATIONS

This application claims priority to and the benefit of U.S. Provisional Patent Application No. 62/166,315, entitled “Illuminated Window Display,” filed May 26, 2015, the entirety of which is hereby incorporated by reference.

### BACKGROUND OF THE DISCLOSURE

Various applications of light guides have been employed for commercial, industrial, and consumer purposes. A light guide operates on the principle of total internal reflection. A light guide transports light when it is present within a material that has a different index of light refraction. For example, a planar optically clear material, such as a window, can transport light when its surrounding medium is air. Light can be extracted from the light guide by altering the interface at the surface of the light guide, such as by replacing the ambient medium that surrounds the light guide with another material to frustrate the total internal reflection at that interface.

### SUMMARY OF THE DISCLOSURE

The present disclosure provides multiple systems and methods for detecting and preventing data exfiltration, while still allowing access to important protocols and services.

An illuminated marking can be created by depositing an illuminable material on the surface of a light guide. This illuminable material could be a decal or a marking deposited by a marker or crayon. When an illuminable material containing a light-diffusing agent is applied to the surface of the light guide, total internal reflection is “frustrated,” allowing light to be extracted by the illuminable material, which then diffuses the light to produce an illuminated marking. For example, writing on an edge-illuminated light guide with a white crayon, or “glow” marker, can produce such an effect.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a top view of an illuminated graphical element rendered on a window pane, according to one implementation;

FIG. 2 is a top view of an illuminated graphical element rendered on a window pane, according to one implementation;

FIG. 3 is a side view of a light injector, according to one implementation;

FIG. 4 is a side view of a light injector, according to one implementation;

FIG. 5 is a side view of a light injector, according to one implementation;

FIG. 6 is a side view of a light injector, according to one implementation;

FIG. 7 is a top view of a light injector, according to one implementation;

FIG. 8 is an exploded view of a light injector, according to one implementation; and

FIG. 9 is a flowchart of a method of illuminating a display, according to one implementation.

The details of various embodiments of the methods and systems are set forth in the accompanying drawings and the description below.

### DETAILED DESCRIPTION

This invention can use a light injector, defined as an edge-illuminated, or otherwise illuminated light guide with an area of optical adhesive deployed to transfer light into another light guide, such as a window, and an illuminable marking or decal, which converts a window pane, or any other planar optically clear material, into an illuminated display. The invention applies the phenomenon of total internal reflection to facilitate illumination. Total internal reflection is commonly deployed in optical fibers to transmit light in optical fibers with little loss through the surrounding surface (the cladding) of the fiber. The process starts when an edge-illuminated light injector composed of an optical material traps light by total internal reflection. This light is then transferred into the window pane by mounting the light injector to the window surface using an optical adhesive with a compatible index of refraction. The adhesive may be an optical liquid such as oil, an optical gel, or an optical solid adhesive, such as an optical acrylic adhesive, such as Optical Adhesive 8142KCL manufactured by 3M. Once the light is present within the window, applying a marker, such as a white crayon, or white window marker, or wet erase glow markers, commonly available, can generate an illuminated marking by disrupting the window-air interface and frustrating the total internal reflection of the light within the window. Applying an illuminable decal to the window can also generate an illuminated marking. White light can be injected into the window, and colored window markers can be used to draw full-color illuminated imagery. Further, UV, or blue light, can be injected into the window, with full-color illuminated imagery created with use of colored fluorescent or phosphorescent markers.

To ensure uniform illumination of an image rendered on a window, a specialized film can be deployed that has a light extraction surface, composed of optimally positioned optically-clear pixels composed of an optically-clear adhesive. This film can be applied to the surface of the light guide to evenly extract light creating a drawing surface that features uniform illumination. In some embodiments, the pixels can be spaced such that the density of the pixels increase with distance from the light injector. In this manner, the film can promote uniform illumination of marking made on the film. Further, a halftone image can be rendered on the surface of the film to facilitate tracing.

The light injector can include a light source comprised of LEDs. The light injector can further include micro-lenses at the interface with the LEDs. The micro-lenses can increase the amount of LED light directed into a light guide of the light injector. The light guide can house the LEDs at one edge, with a first side adjacent to the edge interfacing with a window pane and a second side opposite the first side including features that can direct light into the window pane at the desired angle. The features of the second side of the light guide can include ramps, lenses, or other reflective or focusing features.

To provide for easy installation and removal of the light injector from a window pane, the light injector can be composed of flexible materials and a reusable/repositionable optical adhesive. This permits the removal and re-application of the light injector.

For effective illumination, it is helpful to inject light into the window pane at angles of incidence close to the critical angle of the window-air interface so as to distribute the location of reflections across the window. For example, a glass-air interface can have critical angle of about 45 degrees, while a plastic-air interface can have a critical angle of about 42 degrees. This means any light ray angle within the light guide that is greater than 45 degrees with respect to an axis normal to the interface will be trapped; i.e. reflected internally. Accordingly, although an angle of incidence of 90 degrees would trap the light, the light would not interface with the drawing surface but rather remain internally reflecting repeatedly in or near the location where it was injected into the window pane. Therefore, it can be advantageous to inject the light at an angle close to the critical angle. For example if the critical angle is 45 degrees, a 45-60 degree angle can provide substantial surface interactions across the window pane without being refracted; i.e., the light is still trapped by total internal reflection until reaching a disruption in the window pane-air interface caused by a graphical element such as a marking or decal.

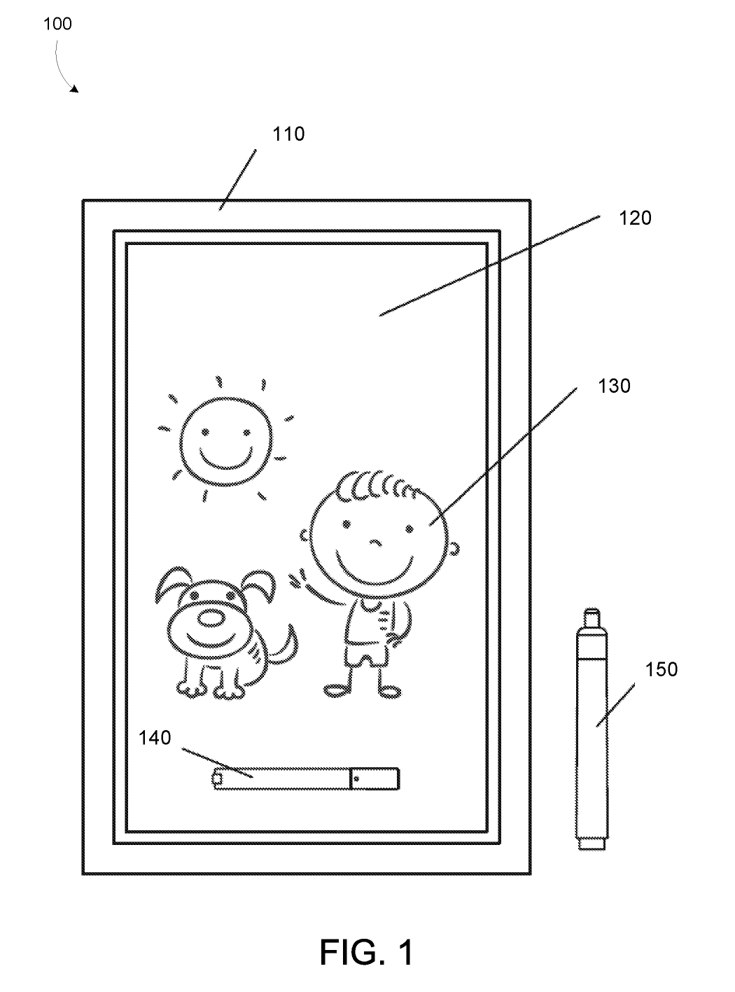

FIG. 1 is a top view 100 of an illuminated graphical element 130 rendered on a window pane 120 of a window 110. A light injector 140 can inject light into the window pane 120 in a manner that can illuminate the graphical element 130. To achieve this, the light injector 140 can take advantage of the phenomenon of total internal reflection at a boundary between two media having different refractive indexes. Total internal reflection occurs when incident light strikes the boundary at an angle greater than the critical angle with respect to an axis normal to the boundary. For example, the light injector 140 can inject light into the window pane 120 at an angle greater than the critical angle for the window pane 120 immersed in air. The light can therefore be internally reflected within the window pane 120 repeatedly until it reaches an end of the window pane 120, or unless something alters the window-air interface. The graphical element 130 can alter the window-air interface in a manner that prevents internal reflection. Instead, the graphical element can frustrate the light and cause it to pass through the boundary between the window-pane 120 and surrounding air. The graphical element can have light dispersion properties that causes rays to emit from the graphical element and make it appear as though the graphical element is illuminated. Because the light is totally internally reflected from unmarked areas of the window pane 120, the rest of the window pane 120 can appear as a normal transparent window or mirror while the illuminated element can produce a striking luminous effect.

The light injector 140 can include a light source, a light guide, and a layer of optical adhesive for affixing the light injector 140 to the window pane 120. The light source can include white, colored, or multi-colored LEDs. The LEDs can be controlled to render multiple colors via steady-state or pulsed light blending. The LEDs may be operated in a rapid strobe fashion to reduce duty cycle and power consumption while maintaining the appearance of steady light. The light source can produce other wavelengths of light such as ultraviolet (UV). In embodiments having a UV light source, the graphical elements 130 can comprise a fluorescent or phosphorescent material that glows in response to incident or transmitted light. The light source can be located adjacent to the light guide. The light guide can pass light from the light source through to the layer of the optical adhesive. The light guide can include one or more layers of transparent or translucent material. The light guide can comprise one or more of a glass, acrylic, polycarbonate, polystyrene, PETG, or copolyester. The light guide can attach to the window pane 120 via the layer of optical adhesive. The layer of the optical adhesive can pass light from the light guide through to the window pane 120. The optical adhesive can be a transparent or translucent liquid, gel, or solid adhesive. The optical adhesive can be a removable and reusable, or permanent adhesive. The optical adhesive can comprise a coupling gel, an oil, or an acrylic adhesive. The refractive indices of the light guide and optical adhesive can be configured for effective transmission of light into the window pane 120. In some embodiments, the refractive indices of the light guide and optical adhesive can be matched, or nearly matched, to that of the window pane 120. For example, the light guide and the optical adhesive can be selected or designed to have a refractive index of about 1.48 for a window pane 120 having a refractive index of 1.50. In some embodiments, the light guide and optical adhesive can be selected or designed such that refractive index of light guide is lower than that of the optical adhesive, which is in turn lower than that of the window pane 120 for which the light injector 140 is designed.

The light injector 140 can be configured such that, when adhered to a window pane, it passes light from the light source into the window pane at an angle greater than a critical angle for total internal reflection of the window pane immersed in air. The critical angle can be measured with respect an axis normal to the boundary between the window pane 120 and air. Light injected into the window pane 120 at an angle greater than the critical angle for internal reflection can reflect back into the window pane 120 from portions of the surface of the window pane 120 interfacing with air. When a graphical element is applied to the surface however, total internal reflection can be frustrated, resulting in light passing through the surface of the window pane 120 and through the graphical element. The light can thus illuminate the graphical element. In this manner, the light can be reflected back into the window pane 120 from a first portion of a surface of the window pane 120 interfacing with air, and the light can be emitted from the window pane 120 from a second portion of the surface of the window pane 120 interfacing with a graphical element. In some embodiments, the graphical element can include graphical elements 130 made by a marker 150. In some embodiments, the graphical elements 130 can include markings made by one or more of a crayon, an illuminable window marker, or an illuminable finger paint.

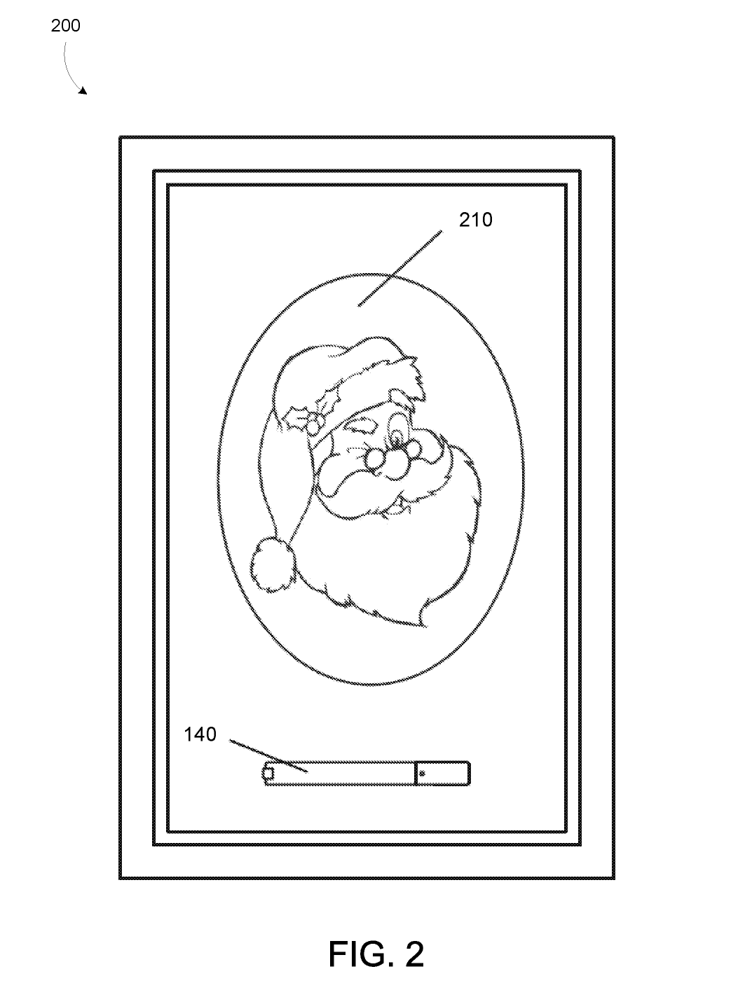

FIG. 2 is a top view 200 of a graphical element 210 rendered on a window pane by a light injector 140. In some embodiments, the graphical element 210 can include an illuminable decal affixed to the window pane. FIG. 2 shows an example illuminated decal. The illuminated decal can comprise a sheet or film, such as vinyl or other polymer that can be adhered either temporarily or permanently on the window pane, with our without the use of an optical adhesive. The illuminated decal 210 can have markings of one or more colors, in solid or in gray scale. In some embodiments, the illuminated decal 210 can include an array of pixels to facilitate extraction of light from the window pane. The pixels can be evenly spaced, or spaced with increasing density across the decal in a direction oriented away from the presumed location of the light injector 140. In this manner, the pixel spacing can be configured to promote uniform illumination of the decal.

The light injector 140 and marker and/or decal can be provided as a kit or package. The kit can include everything necessary to create an illuminated window display on a window pane 120. In some cases, the kit may include a clear plate of glass, acrylic, polycarbonate, or other transparent material. The clear plate can be for practice or demonstration of the device, or for the creation of a sign or display.

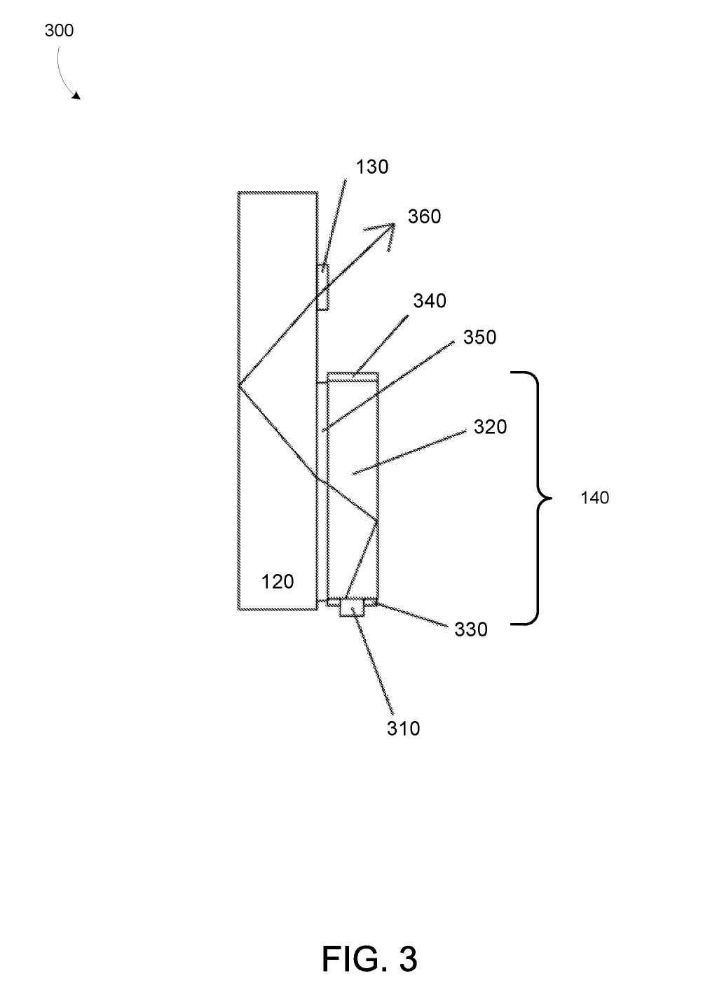

FIG. 3 is a side view 300 of a light injector 140 affixed to a window pane 120. The light injector 140 includes a light source 310, a light guide 320, and a layer of optical adhesive 350. The light source 310 can be positioned on an edge of the light guide 320. The light source 310 can include one or more LEDs for edge illumination of the light injector 140. Both ends of the light injector 140 can be capped by a reflective material 330 and 340. The reflective material 330 and 340 can prevent stray light from leaving the light injector 140 and instead recycle the light back into the light guide for transmission into the window pane 120. The light guide 320 can be bonded to the window pane 140 by the layer of the optical adhesive 350. The layer of the optical adhesive 350 can be positioned on a surface of the light guide 320 adjacent to the edge having the light source 310. The layer of the optical adhesive 350 can facilitate the transmission of light form the light guide 320 into the window pane 120. The light source 310, light guide 320, and layer of the optical adhesive can be configured to inject light 360 into the window pane 120 at an angle offset to an axis normal to the boundary between the window pane 120 and the layer of the optical adhesive 350. The angle of the light 360 can be set such that the light 360 experiences total internal reflection from each boundary between the window pane 120 and air. The angle of the light 360 be set to an angle close to, but still above, the critical angle for the window pane-air interface. For example, a typical critical angle for a glass-air interface may be 45 degrees. The light injector 140 can therefore be set to inject the light 360 at an angle of between 45 and 60 degrees. Injecting the light 360 at an angle close to the critical angel can provide many surface interface events while still maintaining total internal reflection at glass-air interfaces.

The dimensions of the component parts of the light injector 140 can be selected to promote efficient transfer of light into the window pane 120 at the desired angle. The angle of the light within the window pane 120 can be at or higher than the critical angle for total internal reflection. The angle of injection of light may be slightly different than the angel of the light within the window pane 120 due to the refraction that occurs at the interface between the light guide 320 and the optical adhesive 350, and the interface between the optical adhesive 350 and the window pane 120. The amount of refraction can depend on the respective refractive indices of the light guide 320, the optical adhesive 350, and the window pane 120. The angle of injection can be set via design of the geometry of the light guide 320, and choice of material for the light guide 320 and the optical adhesive 350. These parameters can be set to achieve an angle of injection that will result an in-window pane 120 light angle at or above the critical angle. The parameters can be set based on an expected range of possible refractive indices for various window pane 120 materials including various types of glass, acrylics, polycarbonates, or other possible clear plate materials. In general the parameters can be set for an expected refractive index falling between 1.40 and 1.65. In some cases, the range may be narrower; for example 1.45 to 1.55. Accordingly, the angle of injection of light can be between 35 and 45 degrees. In some implementations, the angle of injection can be between 40 and 50 degrees. In some implementations, the angle of injection can be between 45 and 60 degrees.

The light injector 140 can be designed for compatibility with a range of expected thicknesses of the window pane 120. In some implementations, the window pane 120 can be between ⅛″ and ¼″. The width of the light guide 320 and the layer of the optical adhesive 350, measured in a direction across the light guide 320 from the light source 310, can be kept to a length across which the angle of injection can be kept consistent. In this manner, the light injector 140 should inject only a low proportion of the total light injected at an angle that will result in transit within the window pane 120 at an angle less than the critical angle. In some implementations the width of the light guide 320 and the layer of the optical adhesive 350 can be ¼″ to ½″.

A graphical element 130 can be added to the window pane 120 to change the boundary characteristics at the glass-air interface and frustrate total internal reflection. The light 360 can then escape the window pane 120 and illuminate the graphical element 130. In some embodiments, the graphical element 130 can contain a light-diffusing agent, such as titanium dioxide.

In some implementations, the light injector 140 can make up part of an illuminated window display system. Such a system can include a window pane 120, a graphical element 130 on a surface of the window pane 120, and an illumination device adhered to the window pane 120. The illumination device can be, for example, the light injector 140 previously described. The illumination device can include a light source 310, a light guide 320 adjacent to the light source 310 and through which light from the light source 310 passes, and a layer of optical adhesive 350 adjacent to the light guide 320. The layer of optical adhesive 350, when adhered to the window pane 120, can pass light from the light guide 320 into the window pane 120 at an angle greater than a critical angle for total internal reflection of the window pane 120 immersed in air. In this manner, the light can be reflected back into the window pane 120 from a first portion of a surface of the window pane 120 interfacing with air, and the light can be emitted from the window pane 120 from a second portion of the surface of the window pane 120 interfacing with the graphical element 130.

In some implementations, the graphical element 130 can comprise a decal affixed to the window pane 120. The decal can further be integrated with the light injector 140 such that the decal and light injector 140 can be installed on the window pane 120 as a single assembly. The combined decal and light injector 140 can be provided as an integrated sign for affixing to a window pane 120.

In some implementations, the system can include a film adhered to the same side of the window pane 120 to which the illumination device is affixed. The film can include pixels configured to extract light from the window pane and wherein pixel density increases with distance from the illumination device. This configuration can provide for uniform illumination of markings made on the film.

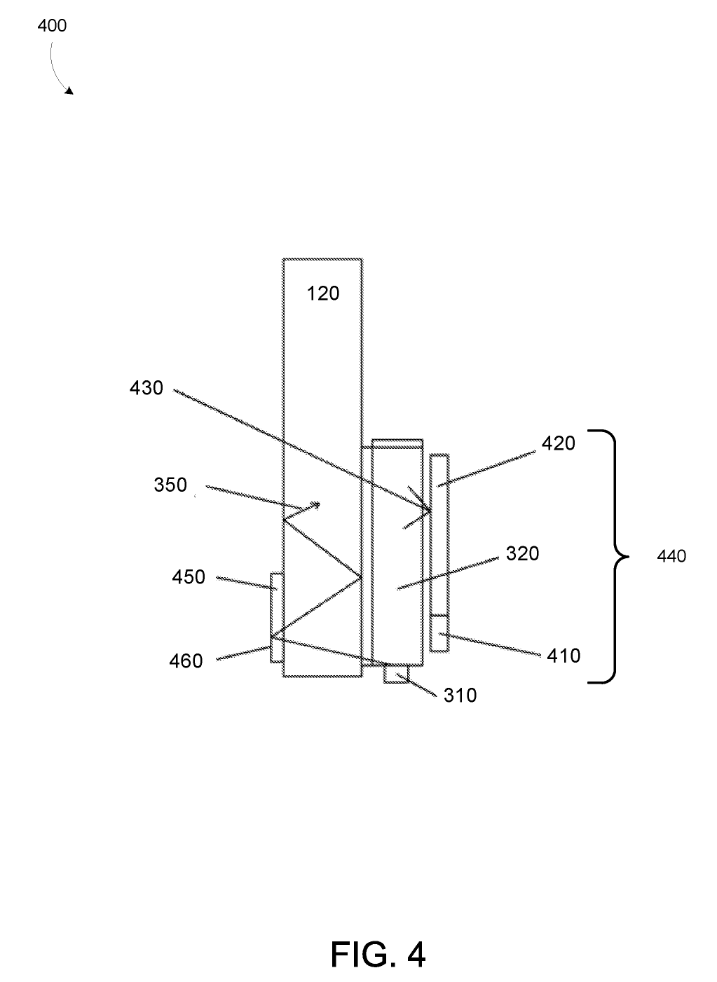

FIG. 4 is a side view 400 of a light injector 440 mounted to a window pane 120. The light injector 440 includes solar panel 420. The solar panel 420 includes solar collection cells 430 for charging one or more solar-chargeable batteries 410.

In some implementations, the light injector 440 can be used in combination with a light-turning reflector 450. The reflector 450 can adhere to a surface of the window pane 120 opposite the light injector 440. The external surface 460 of the reflector 450 can include micro-lenses that can reflect light 350 from the LEDs 310 at angles that promote total internal reflection within the window pane 120. The reflector 450 can promote additional light capture within the window pane 120, ultimately resulting in brighter illumination of the graphical element 130. Although described here in combination with the light injector 440, the reflector 450 can be used in combination with the other light injectors 140, 540, and 640 described elsewhere in this disclosure.

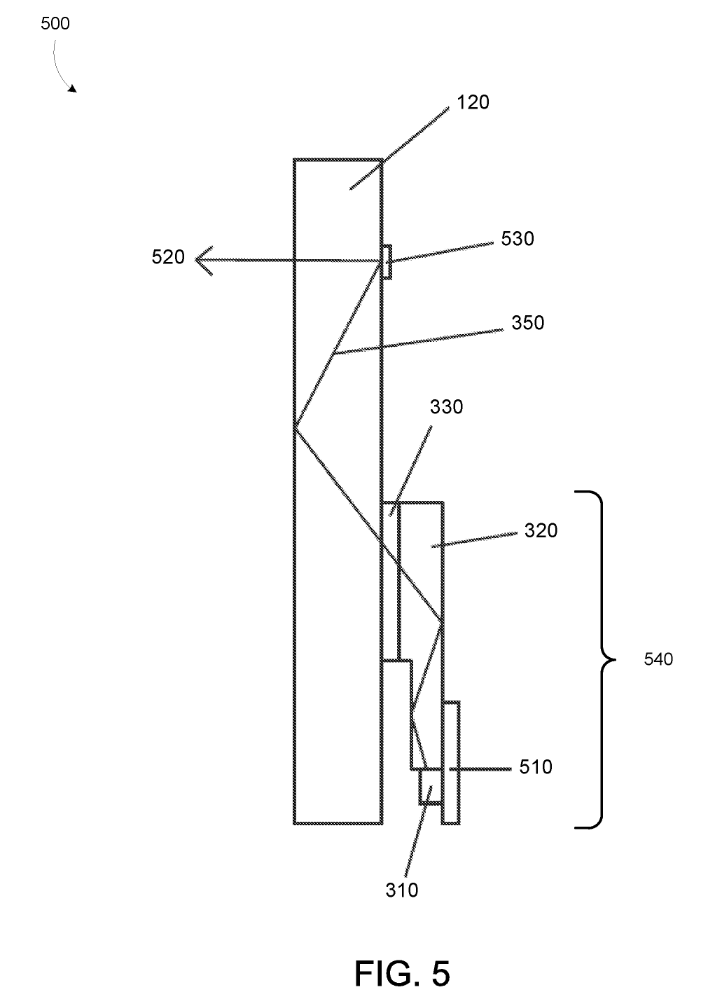

FIG. 5 is a side view 500 of a light injector 540. The light injector 540 can include a printed circuit board (PCB) 510 for mounting the light source 310. The light injector 540 can illuminate a graphical element 530. The graphical element 530 can reflect and diffuse the light 520 back through the window pane 120 at an angle less than the critical angle. The light 520 can then be emitted from the opposite side of the window pane 120. In this manner, the light injector 540 and the graphical element 530 can generate an illuminated window display on the opposite side of the window pane 120 from which the light injector 540 and the graphical element 530 are mounted. In some implementations, the graphical element 530 can direct the light 520 in both directions such that the graphical element 530 appears to be illuminated when observed from either side of the window pane 120.

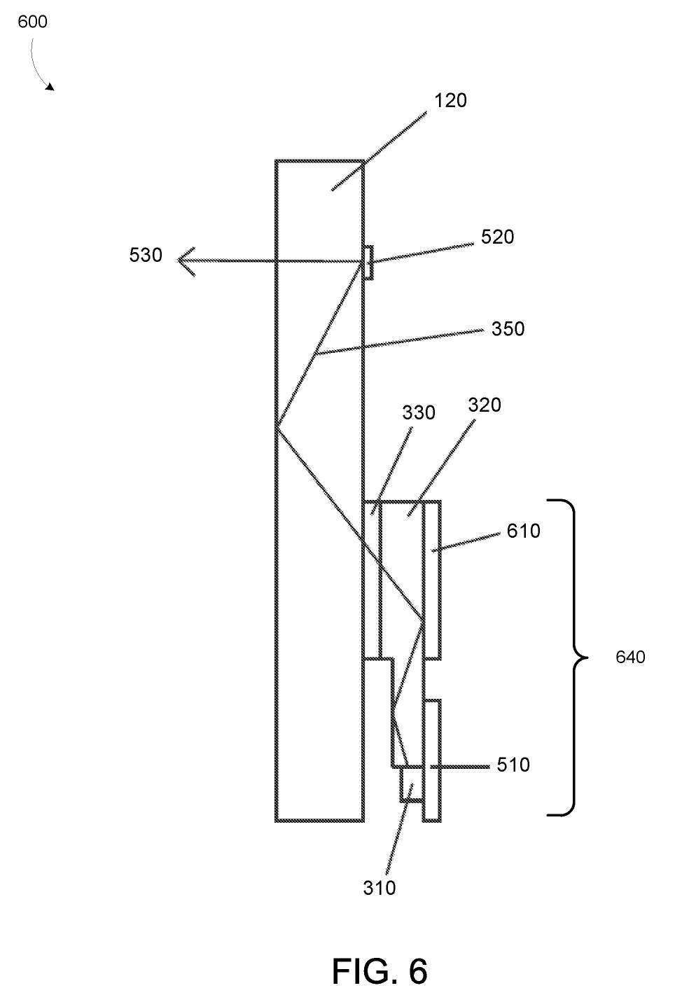

FIG. 6 is a side view 600 of a light injector 640. The light injector 540 can include a solar panel 610 for providing energy to the light source. The PCB 510 can include power conversion and storage electronics for powering the light source 310 using energy gathered by the solar panel 610.

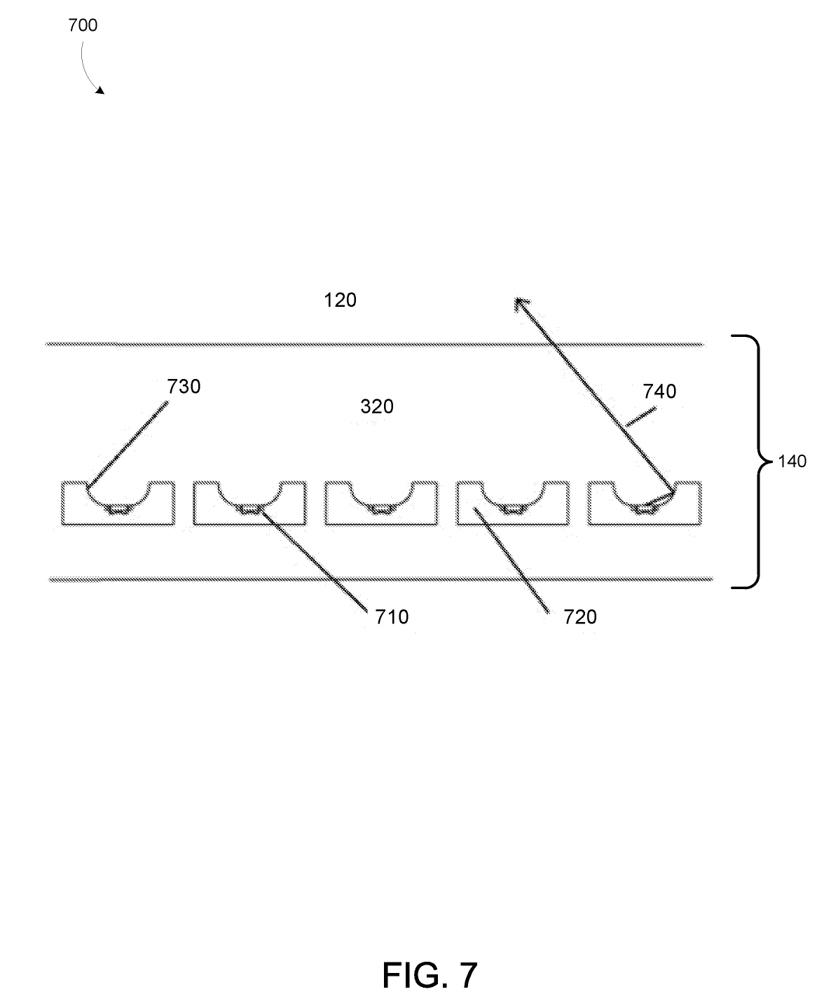

FIG. 7 is a top view 700 of a light injector 140. The top view 700 can also describe aspects of the light injectors 440, 540, and 640. The light injector can include LEDs 710, lens edges 730 at an interface with air 720, and a light guide 320. The light injector 140 can be adhered to a window pane 120. The LEDs 710 can emit light 740, which can be reflected or focused by the lens edges 730 and directed through the light guide 320 and into the window pane 120. The lens edges 730 can be cut by CO2 laser or other appropriate manufacturing techniques. In some embodiments, metallization can be applied to the lens edges 730. The metallization layer can include aluminum. In some embodiments, the light injector 140 can include a 1 mm thick layer of polyethylene terephthalate (PETG) or copolyester. The LEDs 710 can be angled to inject light into the PETG at an angle that promotes total internal reflection of the light from surfaces of the PETG immersed in air, while allowing the light to exit the PETG into the layer of optical adhesive, when the layer of optical adhesive is in contact with the PETG. The layer of optical adhesive can pass the light 740 into the window pane 120.

The light injector 140 can be made from flexible materials to facilitate installation and removal. Removal of the light injector 140 can be accomplished by peeling it away from the window pane 120. When installed, however, the light injector 140 can conform to the flat, or near flat, surface of the window pane 120. In some embodiments, the light injector 140 can conform to curved window panes.

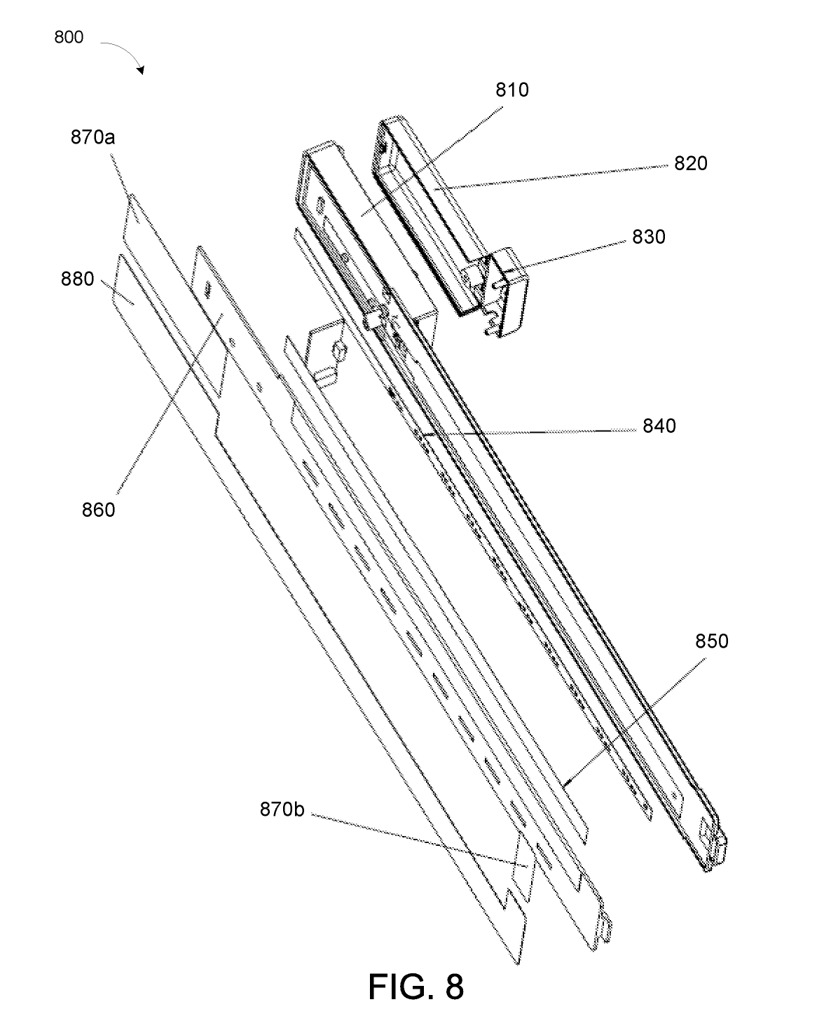

FIG. 8 is an exploded view 800 of a light injector 140. The exploded view 800 can also describe aspects of the light injectors 440, 540, and 640. The exploded view 800 shows a battery box 810, a first battery box cover 820, a second battery box cover 830, an light source PCB 840, a layer of optical adhesive 850, a light guide 860, two patches of two-face adhesive 870a and 870b, and a back decal 880.

In some embodiments, the battery box 810 can be made from a flexible material to provide for easy installation and removal of the light injector 140 onto and off of a window pane 120. The battery box covers 820 and 830 may also include a flexible material. The light source PCB 840 can house LEDs. In some embodiments, the light source PCB 840 can be made from a flexible PCB material such as polyimide. Other materials such as polyester, polyethylene naphthalate, polyetherimide, fluoropolymers, and copolymers may also be suitable for the flexible PCB material. The light guide 860 can be made from a flexible and optically clear material such as a transparent polymer. The light guide 860 can include PETG or copolyester. The light guide 860 can rest flat against the window pane 120. The two patches of two-face adhesive 870a and 870b can provide additional adhesion of the light injector 140 to the window pane 120. This can allow for more flexibility in the choice of optical adhesive because the optical adhesive need not provide all of adhesive strength for mounting the light injector 140 to a window pane 120. The black decal 880 can prevent stray light from escaping the periphery of the light injector 140.

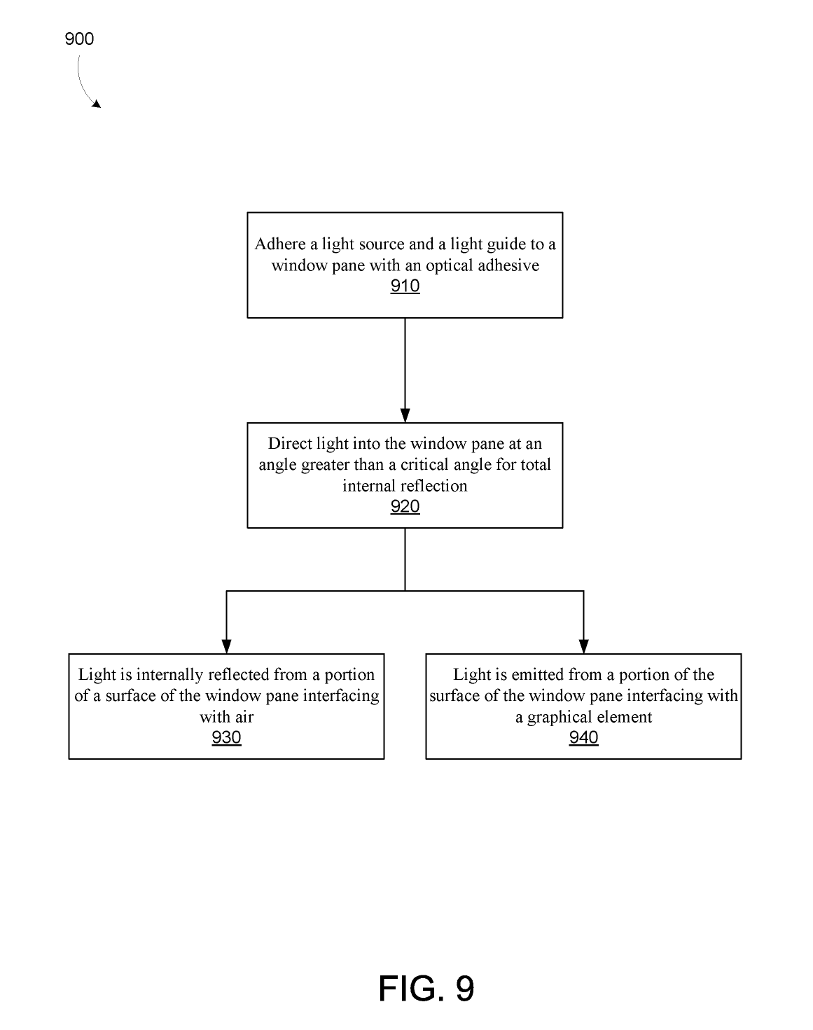

FIG. 9 is a flowchart of a method 900 of illuminating a display. The method 900 can include adhering a light source and a light guide to a window pane with an optical adhesive (Act 910). The method 900 can include directing light into the window pane at an angle greater than a critical angle for total internal reflection of the window pane immersed in air (Act 920). In some implementations, the light can be internally reflected from a first portion of the first surface of the window pane interfacing with air (Act 930). In some implementations, the light can be emitted from the window pane from a second portion of the first surface of the window pane interfacing with a graphical element (Act 940).

The method 900 can include adhering a light source and a light guide including an optical polymer to a window pane with an optical adhesive (Act 910). In some implementations, the light source can comprise multi-color LEDs. The method 900 can include providing colored light via steady-state or pulsed light blending. In some implementations, the graphical element can comprise a fluorescent or phosphorescent material. The method 900 can include providing UV light from the light source to illuminate the graphical element. The light source, light guide, and optical adhesive can make up an illumination device. The illumination device can be mounted to a window, mirror, sign, or any other object including a clear plate. The clear plate can be a home or office window, sliding glass door, wall-mounted sign or mirror, or aquarium or fish tank. The clear plate could also be a type of decoration or container such as a crystal, glass, or plastic vase, decanter, pitcher, bowl, or jug.

The method 900 can include directing light into the window pane at an angle greater than a critical angle for total internal reflection of the window pane immersed in air (Act 920). In some implementations, a first portion of the light can pass through the first surface, and a second portion of the light can be internally reflected from a second surface of the window pane opposite the first surface responsive to the angle. In practice, a large portion of the light directed into the window pane should pass through the first surface of the window pane. If the light is directed into the window pane at the correct angle—that is, an angle greater than the critical angle—substantially all of the light in the window pane should be internally reflected from the second surface of the window pane.

In some implementations, the light can be internally reflected from a first portion of the first surface of the window pane interfacing with air (Act 930). The light can continue internally reflecting from alternate surfaces of the window until and unless the light strikes a surface that has been modified by the addition of a graphical element. The light can be emitted from the window pane from a second portion of the first surface of the window pane interfacing with a graphical element (Act 940). If the light strikes a surface that has graphical element adhered to it, a portion of the light will cross the surface and interact with the graphical element. The light interacting with the graphical element may be reflected, diffused, or both by the graphical element.

In some implementations, the method 900 can include providing energy to the light source using a solar panel. The solar panel can provide power to the light source directly through a power converter, or indirectly by charging a battery.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

We claim:

1. A device, comprising:
a light source;
a light guide adjacent to the light source; and
a layer of optical adhesive adjacent to the light guide,
wherein, when the layer of optical adhesive is adhered to a first surface of a window pane, the light source, the light guide, and the layer of optical adhesive direct light into the window pane at an angle greater than a critical angle for total internal reflection of the window pane immersed in air, and
wherein a first portion of the light passes through the first surface and a second portion of the light is internally reflected, responsive to the angle, from a second surface of the window pane opposite the first surface responsive to the angle.

2. The device of claim 1, wherein the light source comprises multi-color LEDs operable to render multiple colors via steady-state or pulsed light blending.

3. The device of claim 1, wherein the light source is positioned on an edge of the light guide, and the optical adhesive is positioned on a surface of the light guide adjacent to the edge.

4. The device of claim 1, wherein the light guide comprises one or more of a glass, acrylic, polycarbonate, polystyrene, PETG, or copolyester.

5. The device of claim 1, comprising a solar panel for providing energy to the light source.

6. The device of claim 1, wherein the light is internally reflected from a first portion of the first surface of the window pane interfacing with air, and wherein the light is emitted from the window pane from a second portion of the first surface of the window pane interfacing with a graphical element.

7. The device of claim 6, wherein the light source produces UV light and the graphical element comprises a fluorescent or phosphorescent material that glows in response to incident UV light.

8. The device of claim 6, wherein the graphical element includes markings made by one or more of a crayon, an illuminable window marker, or an illuminable finger paint.

9. The device of claim 6, wherein the graphical element includes a decal affixed to the window pane.

10. A method, comprising:
adhering a light source and a light guide to a window pane with an optical adhesive; and
directing light into the window pane at an angle greater than a critical angle for total internal reflection of the window pane immersed in air,
wherein a first portion of the light passes through the first surface and a second portion of the light is internally reflected, responsive to the angle, from a second surface of the window pane opposite the first surface.

11. The method of claim 10, wherein the light source comprises multi-color LEDs, the method comprising:
providing colored light via steady-state or pulsed light blending.

12. The method of claim 10, comprising:
providing energy to the light source using a solar panel.

13. The method of claim 10, wherein the light is internally reflected from a first portion of the first surface of the window pane interfacing with air, and wherein the light is emitted from the window pane from a second portion of the first surface of the window pane interfacing with a graphical element.

14. The method of claim 13, wherein the graphical element comprises a fluorescent or phosphorescent material, the method comprising:
providing UV light from the light source to illuminate the graphical element.

15. A system, comprising:
a window pane;
a graphical element on a surface of the window pane; and
an illumination device adhered to the window pane, the illumination device comprising:
a light source;
a light guide adjacent to the light source; and
a layer of optical adhesive adjacent to the light guide and adhered to a first surface of the window pane, the light guide and the layer of optical adhesive directing light into the window pane at an angle greater than a critical angle for total internal reflection of the window pane immersed in air,
wherein a first portion of the light passes through the first surface and a second portion of the light is internally reflected, responsive to the angle, from a second surface of the window pane opposite the first surface, and
wherein the light is internally reflected from a first portion of the first surface of the window pane interfacing with air, and wherein the light is emitted from the window pane from a second portion of the first surface of the window pane interfacing with a graphical element.

16. The system of claim 15, comprising a solar panel for providing energy to the illumination device.

17. The system of claim 15, wherein the graphical element includes a decal affixed to the window pane, and the decal is integrated with the illumination device such that the decal and illumination device can be installed on the window pane as a single assembly.

18. The system of claim 17, wherein the decal comprises pixels configured to extract light from the window pane and wherein pixel density increases with distance from the illumination device.

19. The system of claim 17, comprising:
a film adhered to the second surface of the window pane, the film having an external surface containing micro-lenses for promoting additional total internal reflection within the window pane by adhesion to the external surface of the window pane.

20. The system of claim 13, wherein the light source is positioned on an edge of the light guide, and the optical adhesive is positioned on a surface of the light guide adjacent to the edge.
